(19) United States
(12) Patent Application Publication
(10) Pub. No.: US 2007/0235610 A1
(43) Pub. Date: Oct. 11, 2007

(54) Bracket assembly for window-mounted AC unit

(76) Inventor: Sean T. Flanigan, Falmouth, ME (US)

Correspondence Address: BOHAN, MATHERS & ASSOCIATES, LLC, PO BOX 17707, PORTLAND, ME, 04112-8707, US

(21) Appl. No.: 11/393,490

(22) Filed: Mar. 30, 2006

(51) Int. Cl. A47B 96/06; F16M 7/00

(52) U.S. Cl. 248/231.71

(57) ABSTRACT

A bracket assembly for supporting an AC unit in a window. The assembly includes a C-shaped bracket, adhesive means, and sash stops. The bracket fits within the outer window sill and, together with the upper edge of the lip on the inner sill, provides a secure surface for the AC unit to rest upon. The bracket is adhesively affixed to the outer window sill, to prevent it from being knocked out of place during installation of the AC unit. No external support means that require drilling into the outside wall are required.

### BACKGROUND INFORMATION

1. Field of the Invention

The invention relates to the field of windows. More particularly, the invention relates to a support for a window-mounted air conditioner unit.

2. Description of the Prior Art

Air conditioner units (AC units) are often installed in window openings. The AC unit is placed on the window sill and the lower sash lowered onto the top of the AC unit. The AC unit, being much larger than the dimension of the window sill, overhangs to a significant extent the window sill. The vinyl lip of the sill is not designed to support the weight of the AC unit and typically an additional support is required that will prevent it from falling off the sill and distribute the weight to another structural element that can provide the necessary support.

Most supports are mounted on an outside wall beneath the window sill and require that a bracket be fastened to the wall by means of threaded fasteners. This support system is disadvantageous in that it is cumbersome to install and requires some technical sophistication to properly secure the support to the outside wall.

What is needed, therefore, is a mounting system that is simple to install and does not require that holes be drilled into the outside wall in order to install the mounting system.

### BRIEF SUMMARY OF THE INVENTION

It is an object of the invention to provide a system that securely supports a window-mounted AC unit in the window opening. It is a further object to provide such a system that is not mounted directly on a wall. It is a yet further object to provide such a system that is easy to install and does not require that holes be drilled into a wall.

The AC support system according to the invention provides a support means that is mounted directly on an outer window sill and which provides a level support surface for supporting the AC unit. The lower edge of the typical window opening has an outer window sill, which slopes downward away from the outside wall, and an inner window sill, the upper edge of which is higher than the sloping surface of the outer window sill. The AC support system comprises a bracket assembly that includes a support bracket and attachment means, and sash stop material. The support bracket is a C-shaped bracket with an upper support surface, a lower support surface and a vertical wall connecting the two support surfaces. The shape and slope of the lower surface of the support bracket conforms to the specific shape and slope of the outer window sill. In the preferred embodiment, the attachment means is a double-sided adhesive that is used to fasten the bottom of the lower surface of the support bracket to the window sill. Other conventional attachment means, such as a glue applied directly to the outer window sill, may also be used. Mechanical fasteners, such as screws, rivets, nails, etc., would also hold the bracket to the window sill, but are not recommended, as such fasteners would provide a path for water into the window unit or wall of the building. The height of the support bracket is constructed such that, when installed, the support bracket, together with the upper edge of the inner window sill, provides a two point horizontal support plane for the AC unit to rest upon. Ideally, the height of the support bracket is slightly lower than that of the inner window sill, so that the AC unit slopes very slightly downward toward the outside.

Installation of the AC support system is simple. The support bracket is cut to length, as necessary, so that it fits within the width of the outer window sill. The support bracket is centered between the window jambs and the attachment means applied to secure the support bracket to the outer window sill. Ideally, the support bracket is installed so that the rear edge of the support bracket rests against the outside edge of a bug screen track. The AC unit is then placed on the inner window sill and the support bracket. The window lower sash is lowered onto the AC unit and the AC unit attached to the window in a manner known to the art.

It may be desirable to prevent the lower sash from rising up away from the AC unit. The AC support system includes the sash stops for this purpose. The sash stops are elongate sections of extruded material that snap into the jamb pockets provided in the window jambs on each side of the window frame. Frequently, with conventional vinyl windows, a sash stop is provided, in the lower portion of the jamb pockets for the upper sash, for example, to prevent the upper sash from being completely lowered down to the window sill. This same sash stop material is provided as part of the AC support system, and of sufficient length that it can be cut to fit the particular application. To install the sash stops, the distance between the top of the lower window sash and the head of the window is measured. Two sash stops are then cut to that length from the sash stop material. The two sash stops snap fit into the jamb pockets for the lower sash, above the upper edge of the lower window sash, which has been lowered into position against the AC unit. The sash stops are secured in place by means of threaded fasteners provided with the AC support system.

The support bracket and sash stops are constructed of a form rigid material, such as a metal or a plastic that is strong enough to support the weight of an AC unit and is easily adaptable in length. In the preferred embodiment, the support bracket is constructed of aluminum and the sash stop material of an extruded plastic.

### BRIEF DESCRIPTION OF THE DRAWINGS

The present invention is described with reference to the accompanying drawings. In the drawings, like reference numbers indicate identical or functionally similar elements.

FIG. 1 is cross sectional elevational view of a window, showing an AC unit and the AC support system according to the invention installed in the window.

FIG. 2 is a perspective drawing of the bracket assembly.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be complete and will fully convey the scope of the invention to those skilled in the art.

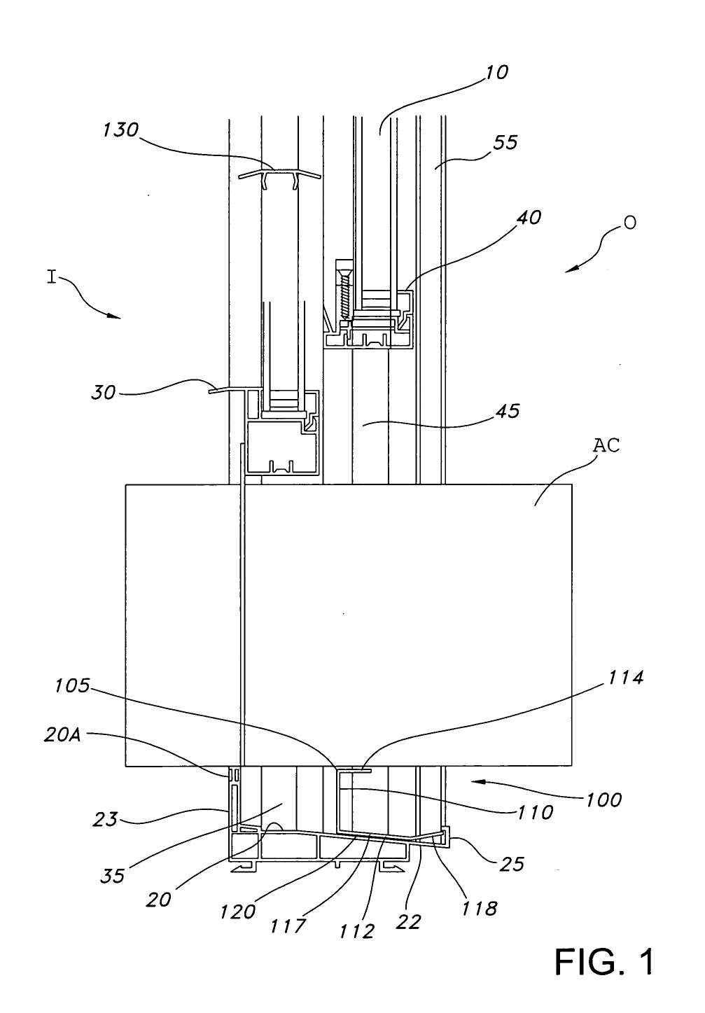

FIG. 1 shows a cross-sectional elevational view of an AC support system 100 installed in a window 10 and supporting a conventional AC unit AC. The designation I indicates the inside and the designation O the outside of a wall in which the window 10 is installed. The AC support system 100 comprises a bracket assembly 105 and sash stop material 130 for cutting sash stops 132. The sash stop material 130 is shown turned 90 degrees relative to the horizontal plane, to better illustrate its profile. In actuality, the sash stop material 130 is an elongate piece that snaps or fits into the jamb pockets provided on the window frame, and is provided with conventional windows to prevent the sash from being moved up or down beyond a certain point. The bracket assembly 105 comprises a support bracket 110 and, preferably, attachment means 120. The window 10 has an inner window sill 20, an outer window sill 22 with a bug screen track 25. The inner window sill 20 has an upper edge 20A and the outer window sill slopes downward. The window 10 also includes an upper sash 40 located in an upper sash jamb pocket 45, a lower sash 30 installed in a lower sash jamb pocket 35, and a screen track 55, which has a screen track lip 25. Any balance covers that are assembled on the window (not shown) should be removed and stored for later use, when the AC unit has been removed from the window.

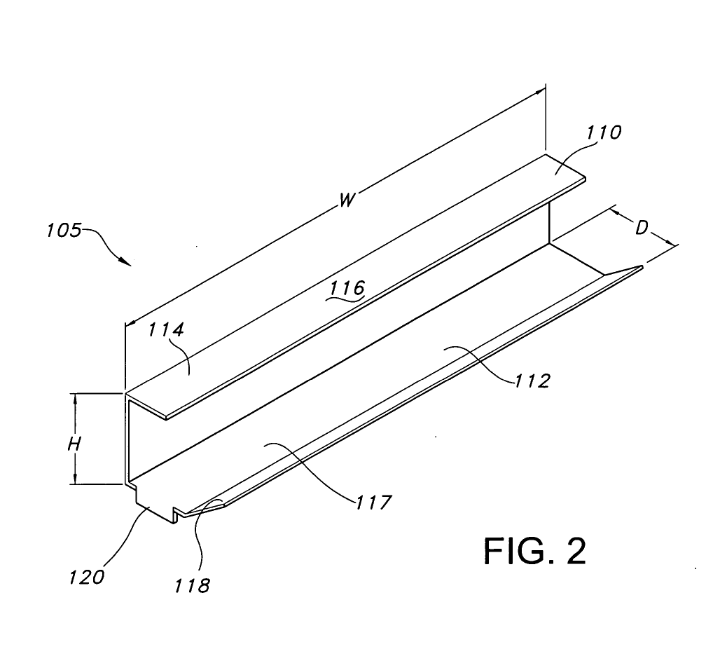

FIG. 2 is a perspective drawing of the bracket assembly 105, showing the attachment means 120 already attached to the bracket 110. The support bracket 110 has a C-shaped body 117 defined by a lower support surface 112, an upper support surface 114, and a vertical connecting wall 116 therebetween. The connecting wall 116 has a height H such that, after installation, the upper support surface 114 and the upper edge of the sill 20A provide a two point, support means for securely supporting the AC unit A. Preferably, the height of the upper support surface 114 is slightly lower than that of the upper edge of the sill 20A, so that the support means slopes very slightly downward toward the outside O. The support bracket 110 has a length adaptable to fit the width of the sill 20. In the preferred embodiment, the width of the support bracket, indicated with width indicator W, is adapted to be approximately 1.5 inches shorter than the width of the sill 20. This is recommended, to ensure some free space at both ends of the sill that provides an unobstructed path for water to flow down into a weep system. The attachment means 120, in the preferred embodiment, is a double sided adhesive strip 122 with a first side attached to the bottom of the support bracket lower surface 112 and a second side covered by a backing known to the art. As mentioned above, glue may be used, as well as other types of fasteners, although it is not recommended to use any fastener that requires making a hole in the window sill. It should be noted that the attachment means 120 is optional. Its purpose is to secure the support bracket 110 in position on the outer window sill 22 while the AC unit AC is being installed. Without such attachment means, the support bracket 110 could easily be knocked off the outer window sill 22 or out of position by the AC unit during the installation process.

The lower surface 112 of the bracket 110 has a tail 118. In the preferred embodiment of the invention, the outer contour of the lower support surface 112 conforms to the slope of the sill floor 21 of the intended installation, and a tail 118. A weep system is typically incorporated into the screen track 55, with weep holes provided in the bottom of the track to drain off moisture. The tail 118 is constructed to catch under the screen track lip 25, raised above the surface of the sill, so as not to block the weep holes. The lower support surface 112 has a depth D indicated by depth indicator D. The upper support surface 114 is shown as having a depth that is significantly less than D. The depth of the upper support surface 114 has to be great enough to provide a secure support, and is not limited to a particular depth. Having the depth less than the depth of the outer window sill 22 is advantageous for several reasons. For example, a foreshortened depth of the upper support surface 114 allows one to leave the bracket 110 to installed in the window 10, even when the AC unit has been removed for the season; it requires less material to make, and it facilitates the bending process, if the bracket 110 is formed with a bending brake.

To install the conventional AC unit AC, the lower sash 30 is raised. Any balance covers (not shown) are removed from the lower sash jamb pockets 35. The width of the sill is measured, and if necessary, the support bracket 110 length adjusted to fit therein. Protective backing is removed from the adhesive strip 122. The support bracket 110 is positioned on the sill 20 such that it rests centered between the upper sash jamb pockets 45, and the tail 118 rests against the screen lip 25. The adhesive strip 120 fixedly attaches the support bracket 110 to the sill 20. The AC unit AC is installed so that it rests on the sill 20 and the support bracket 110. The lower sash 30 is lowered onto the AC unit AC and the AC unit AC is fixedly attached to the window 10 in a manner known to the art.

The sash stop material 130 is cut to length to make sash stops 132 that fit in the jamb pockets 35 To determine the proper length of the sash stops 132, the distance between the top of the lower sash 30 and the head (not shown) of the window 10 is measured. Two sash stops 132 are cut to that measured length. These sash stops 132 are then fitted into the lower sash jamb pocket 35 in the space between the head of the window 10 and the top of the lower sash 30 and fixedly attached with a fastener known to the art. The purpose of the sash stops 132 is to prevent the lower sash 30 from being raised inadvertently.

The support bracket 110 and the sash stop 130 material are preferably constructed of a rigid material, such as metal, plastic, or other form rigid material that provides the necessary rigidity and strength, and is readily adaptable in length, without requiring sophisticated tools and mechanical skills. In a preferred embodiment, the support bracket 110 is shaped from sheet aluminum, although it could also be extruded, and the sash stop material 130 is an extruded vinyl material.

It is understood that the embodiments described herein are merely illustrative of the present invention. Variations in the construction of the AC support system may be contemplated by one skilled in the art without limiting the intended scope of the invention herein disclosed and as defined by the following claims.

What is claimed is:

1. A bracket for supporting an AC unit in a window, said window having an inner sill with an inner sill lip and an outer sill, said outer sill having an outer sill width bounded by window jambs and an outer sill depth that includes a screen track with a screen track lip, said bracket comprising:
a support means for installation on said outer sill, said support means having a lower surface, an upper surface, and a vertical support wall therebetween, said support means adaptable in width to fit within said outer sill width;
wherein a contour of said lower surface conforms to a contour of said outer sill and wherein said lower surface has a depth that fits within said outer sill depth; and
wherein said lower support surface has a tail adapted to fit under said screen-track lip when said bracket is installed.

2. The bracket of claim 1, wherein said upper surface has an upper surface depth that is less than said outer sill depth.

3. A bracket assembly for supporting a window-mounted AC unit in a window, said window having an inner sill with an inner sill lip and an outer sill, said outer sill having an outer sill width bounded by window jambs and an outer sill depth that includes a screen track with a screen track lip, said bracket assembly comprising:
a support means having a lower surface, an upper surface, and a vertical support wall therebetween; and
an attachment means for affixing said support means to said outer sill;
wherein said support means and said attachment means are adjustable in width to fit within said sill width; and
wherein a contour of said lower surface conforms to a contour of said outer sill and wherein said lower surface has a depth that fits within said outer sill depth.

4. The bracket assembly of claim 3, wherein said attachment means is an adhesive.

5. The bracket assembly of claim 3 further comprising a sash stop means for preventing a lower sash from inadvertently being raised.
